(19) United States
(12) Patent Application Publication
(10) Pub. No.: US 2019/0143396 A1
(43) Pub. Date: May 16, 2019

(54) CORE FOR HIGH-TEMPERATURE SHAPING OF A METAL PART AND MANUFACTURING PROCESS

(71) Applicants: SAFRAN AIRCRAFT ENGINES, Paris (FR); SAFRAN, Paris (FR); Centre National De La Recherche Scientifique, Paris (FR)

(72) Inventors: Gilles Charles Casimir KLEIN, Moissy-Cramayel Cedex (FR); Jean-Michel Patrick Maurice FRANCHET, Moissy-Cramayel Cedex (FR); Yann LEPETITCORPS, Leognan (FR); Jerome ROGER, Pessac (FR); Benoit SERGENT, Pessac (FR)

(73) Assignees: SAFRAN AIRCRAFT ENGINES, Paris (FR); SAFRAN, Paris (FR); Centre National De La Recherche Scientifique, Paris (FR)

(21) Appl. No.: 16/092,922

(22) PCT Filed: Apr. 10, 2017
(86) PCT No.: PCT/FR2017/050851

§ 371 Date: Oct. 11, 2018

(30) Foreign Application Priority Data
Apr. 12, 2016 (FR) 1653221

(51) Int. Cl. B21D 53/78; B21D 37/01; B21D 35/00; C23C 8/30; C23C 8/02; F01D 5/14

(52) U.S. Cl. CPC B21D 53/78; B21D 37/01; B21D 35/005; C23C 8/30; C23C 8/02; F05D 2230/25; F05D 2220/36; F05D 2240/303; F05D 2300/174; F05D 2230/10; F01D 5/147

(57) ABSTRACT

A metal core for hot-shaping a metal part made out of titanium-based alloy. The metal core presents on an outside surface that is to come into contact with the metal part, a layer of material enriched in metallic carbonitride. The metal core includes an alloy based on nickel or on cobalt, and the nickel- or cobalt-based alloy includes chromium, molybdenum, and/or titanium. A method of fabricating and regenerating the metal core, and also a method of fabricating a metal part using the metal core, are disclosed.

### BACKGROUND OF THE INVENTION

The present invention relates to fabricating a metal part out of titanium based alloy, such as a leading edge shield for a turbine blade.

Such leading edge shields are typically used for protecting the leading edges of rotary blades against impacts. In this context, the term “blades” is used to cover both fan blades and aircraft propeller blades. In order to limit their weight, such blades are typically made out of fiber-reinforced polymer-matrix composite material. Although such materials present mechanical qualities that are generally very favorable, in particular relative to their weight, they are particularly sensitive to point impacts, which can give rise, in particular, to phenomena of delamination within the material. Shields, typically made of very strong metal material, such as titanium alloys, are thus normally installed on the leading edges of such blades, in order to protect them against impacts. Such shields are normally in the form of a fine pressure-side fin and a fine suction-side fin that are joined together by a thicker section placed astride the leading edge, the shield fitting closely to the shape of the blade on the leading edge and on its adjacent pressure- and suction-side sections. The pressure- and suction-side fins extend respectively over those pressure- and suction-side sections of the blade, and they serve mainly to position and fasten the shield on the leading edge.

In order to improve the aerodynamic performance of blades, their leading edges are being given shapes that are ever more complex, thereby making it more complicated to fabricate shields that are to fit those shapes closely.

In one method, the shield is fabricated mainly by forging, starting from an alloy bar, using successive steps of bending, ramming, and extrusion, and with a final step of twisting in order to move the fins closer to each other and in order to calibrate the thicker section. Applying that known method to materials that are as strong as the titanium alloys typically used for leading edge shields nevertheless presents major drawbacks: high fabrication costs due to significant wear of the forging tools and to a large number of fabrication steps and to technical drawbacks due to the great difficulty of obtaining very fine thicknesses for the fins or small transition radii between the fins and the thicker section.

Document WO 2011/114073 describes a method of hot-forming a shield around a core. The core may optionally be covered in an anti-diffusion barrier made of a layer of yttrium oxide. Nevertheless, that layer of yttrium oxide needs to be deposited by plasma deposition. That technique has a cost that is relatively high and it can be difficult to obtain a layer that is uniform over the entire outside surface of the core. Specifically, the ever more complex shapes of blades, and thus of the leading edges of such blades, also causes the core on which the leading edge is shaped itself to be of ever more complex shape.

Furthermore, it is found that the layer of yttrium oxide degrades relatively quickly, thereby restricting the potential for reusing the core. Thus, the cost of such a method is relatively high.

### OBJECT AND SUMMARY OF THE INVENTION

The present invention seeks to remedy those drawbacks.

To this end, the invention provides a metal core for hot-shaping a titanium-based metal part, the metal core comprising an alloy based on nickel or on cobalt, and the nickel- or cobalt-based alloy including chromium, molybdenum, and/or titanium, and the metal core also presenting on an outside surface that is to come into contact with the metal part, a layer comprising a material that is enriched in metallic carbonitride relative to said alloy.

Because the metal core comprises a nickel- or cobalt-based alloy, it is possible to hot-shape a metal part made out of titanium-based alloy, such as a metal part that is to form a leading edge of a rotary blade. By hot plastic deformation of the metal part, this hot-shaping serves to fabricate a part having a three-dimensional shape that is complex, even when starting with metal sheets that are particularly rigid and that present physical properties that are particularly advantageous, in particular great fatigue strength. Specifically, nickel- or cobalt-based alloys deform little or not at all at high temperatures, e.g. 1000° C.

Furthermore, because of the layer of material enriched in metallic carbonitride that is present on the outside surface of the metal core for coming into contact with the metal part, the metal core and the metal part can be separated easily after the metal part has been hot-shaped on the metal core. Specifically, during the hot-shaping step, there is no sticking and/or chemical reaction between the metal core and the metal part. Specifically, the metal part is in contact with the layer of material enriched in metallic carbonitride and not with the nickel- or cobalt-based alloy forming the metal core.

This layer of material enriched in metallic carbonitride is chemically and physically inert relative to the metal part. As a result of its dispersed carbides and nitrides, this layer forms a diffusion barrier between the alloy of the metal core and the titanium-based alloy of the metal part. This serves to limit contamination of the metal part made out of titanium-based alloy by the elements of the nickel- or cobalt-based alloy of the metal core.

Also because of the fact that the nickel- or cobalt-based alloy includes chromium, molybdenum, and/or titanium, the layer of material enriched in metallic carbonitride that is formed at the surface of the metal core is stable at high temperature, in particular it is thermodynamically stable. It should also be observed that the greater the weight content in chromium, molybdenum, and/or titanium, the greater the stability of the layer of material enriched in metallic carbonitride.

Thus, the metal core can be used to hot-shape the metal part so as to give it a three-dimensional geometrical shape that is complex, requiring little or no machining of the surface of the metal part that has been in contact with the metal core after the metal core has been removed. This metal core presenting a surface that is inert relative to the metal part can be used for hot-shaping a plurality of metal parts in succession. The metal core is thus a tool that can be used for fabricating a plurality of metal parts and it is not a consumable that is used for shaping only one metal part.

The term “titanium-based alloy” is used to cover alloys in which the mass content of titanium is in the majority. It can be understood that titanium is thus the element having the greatest mass content in the alloy. Advantageously, the titanium-based alloy has a mass content of titanium that is at least 50%, preferably at least 70%, or indeed more preferably at least 80%. In the same manner, the term nickel- or cobalt-based alloy is used to mean metal alloys in which the mass content of nickel or cobalt is in the majority. Thus, the nickel- or cobalt-based alloy may have a mass content of nickel or of cobalt of at least 40%, preferably at least 50%.

The material enriched in metallic carbonitride may be obtained by diffusing atoms of carbon and nitrogen into a metal alloy. These atoms of carbon and nitrogen react with the atoms of the metal alloy to form a layer of material that has the atoms of the starting metal alloy bonded to atoms of carbon and/or of nitrogen. This layer may comprise carbides, nitrides, and/or metallic carbonitrides of chemical and weight compositions that vary as a function of the locations where they are measured in the layer. It can be understood that the layer may also have atoms of the original metal alloy that are not bonded to atoms of carbon or of nitrogen.

The layer of material enriched in metallic carbonitride may comprise a first layer and a second layer, the first layer having a greater concentration of metallic nitride than the second layer, the second layer being separated from the outside surface of the metal core by the first layer.

Since carbon has greater mobility than nitrogen in nickel- or cobalt-based alloys, it can diffuse through a greater thickness than nitrogen in a given time period. The combined use of carbon and of nitrogen makes it possible to form a compound that is thermodynamically stable, e.g. over a depth that is greater than about 20 micrometers (μm), preferably greater than 30 μm.

The layer of material enriched in metallic carbonitride may present a thickness of at least 20 μm, preferably of at least 30 μm.

Thus, the layer of material enriched in metallic carbonitride is thick enough for the core to be capable of being used at least ten times, or even 30 times or 50 times. This significant reuse of the metal core makes it possible to reduce the cost of producing leading edges very significantly.

The invention also provides a fabrication method for fabricating a metal core as defined above, the method comprising the following steps:
fabricating the metal core; and
carbonitriding the outside surface of the metal core in such a manner as to obtain a layer of material enriched in metallic carbonitride.

By thermodynamically controlling the carbonitriding, it is possible to enhance the formation of certain nitrides, carbides, and/or carbonitrides. Of all of the metal elements present in the alloy, certain elements form carbides, e.g. chromium, iron, molybdenum, tungsten, titanium, tantalum, niobium, and aluminum, while others form nitrides, e.g. chromium, iron, molybdenum, tungsten, titanium, tantalum, niobium, and aluminum, and some of these elements form carbonitrides, in particular titanium, tantalum, and iron. Nickel and cobalt are metal elements that are neutral relative to carbon and nitrogen, such that they do not bond with carbon and/or nitrogen to form nitrides, carbides, and/or carbonitrides. Furthermore, the depth to which carbon or nitrogen diffuse is controlled by the kinetics of the reaction, e.g. by modifying the carbonitriding temperature.

The carbonitriding may be performed in a bath of molten salts under a gas atmosphere.

The outside surface of the metal core may in particular be carbonitrided by forming a plasma of carbon and of nitrogen. This technique is also called iron carbonitriding or plasma carbonitriding and it is a reactive technique that makes it possible to cause carbon and nitrogen to diffuse deeply. By varying the temperature, it is possible to control the thickness of the layer of material enriched in metallic carbonitride that is formed at the surface of the metal core.

The invention also provides a regeneration method for regenerating a metal core as defined above, wherein a new step of carbonitriding the outside surface of the metal core is performed so as to obtain a new layer of material enriched in metallic carbonitride.

Thus, when after a plurality of uses of the metal core, e.g. ten uses, preferably 30 uses, still more preferably 50 uses, the layer of material enriched in metallic carbonitride has become degraded, it is possible to perform a new carbonitriding step. This thus makes it possible to prolong the lifetime of the metal core.

Prior to the new step of carbonitriding the outside surface of the metal core, a step of using heat treatment to eliminate the layer of material enriched in metallic carbonitride may be performed. Typically, this step is performed at a temperature higher than the hot-shaping temperature for the metal part.

The invention also provides a shaping method for hot-shaping a metal part made out of titanium-based alloy, the method comprising the following steps:
positioning the metal part around a metal core as defined above;
hot-shaping the metal part around the core; and
extracting the core.

Thus, by using a metal core that presents at its surface a layer of material enriched in metallic carbonitride, it is possible to fabricate a metal part made out of titanium-based alloy by hot-shaping without the metal core and the metal part sticking together and without contaminating the metal part with the alloy of the metal core. Furthermore, the surface of the metal part in contact with the metal core needs little or no machining, which is economically advantageous. It should also be observed that the cost of producing a leading edge is reduced, given that the same core can be reused several times, e.g. at least ten times.

Advantageously, the metal part is a leading edge shield of a rotary blade.

### BRIEF DESCRIPTION OF THE DRAWINGS

The invention can be well understood and its advantages appear better on reading the following detailed description of an embodiment given by way of non-limiting example. The description refers to the accompanying drawings, in which:

FIG. 1 is a diagrammatic perspective view of a bypass jet engine;

FIG. 2 is a diagrammatic perspective view of a rotary blade of the fan of the FIG. 1 jet engine;

FIG. 3 is a diagrammatic perspective view of a shield for the leading edge of the FIG. 2 blade;

FIG. 4 is a cross-section view on plane IV-IV of the FIG. 3 shield;

FIGS. 5A to 5E show successive steps in a method of fabricating the FIG. 4 shield;

FIG. 6 is an enlarged section view of a metal core; and

FIGS. 7A and 7B are graphs showing respectively the concentrations of carbon and of nitrogen starting from the surface of the metal core.

### DETAILED DESCRIPTION OF THE INVENTION

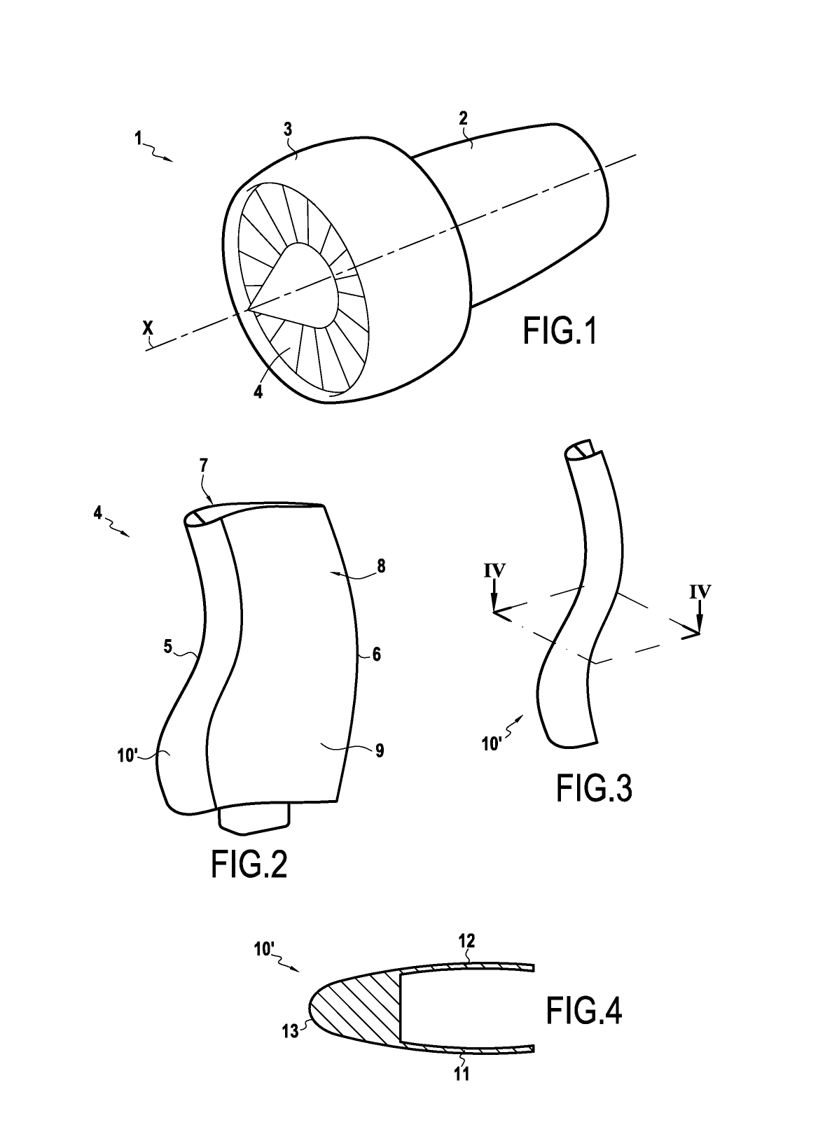

FIG. 1 shows a bypass jet engine 1 having a gas generator unit 2 and a fan 3. The fan 3 has a plurality of rotary blades 4 arranged radially around a central axis X and aerodynamically profiled in such a way as to impel air when they rotate. Thus, as shown in FIG. 2, each blade 4 presents a leading edge 5, a trailing edge 6, a suction side 7, and a pressure side 8.

In normal operation, the relative air flow is directed substantially towards the leading edge 5 of each blade 4. Thus, the leading edge 5 is particularly exposed to impacts. In particular when the blade 4 has a body 9 made out of composite material, in particular out of fiber-reinforced polymer-matrix material, it is therefore appropriate to protect the leading edge 5 with a shield 10′ incorporated in each blade.

FIGS. 3 and 4 show this shield 10′, which presents a pressure side fin 11, a suction side fin 12, and a thicker central section 13 that is to be placed astride the leading edge of the blade 4 and interconnecting the pressure side fin 11 and the suction side fin 12. The pressure- and suction-side fins 11 and 12 serve to position the shield 10′ on the blade 4. The shield 10′ is made mainly out of metal, and more specifically out of titanium-based alloy, e.g. such as TA6V (Ti-6Al-4V). The shield 10′ is thus an example of a metal part 10 made of titanium-based alloy.

As can be seen in FIGS. 3 and 4, the shape of this shield 10′ is rather complex, which, in combination with the high performance materials typically used for this part, can make it expensive and difficult to fabricate, in particular when the core traditionally used for hot-shaping the leading edge can be used only one or two times.

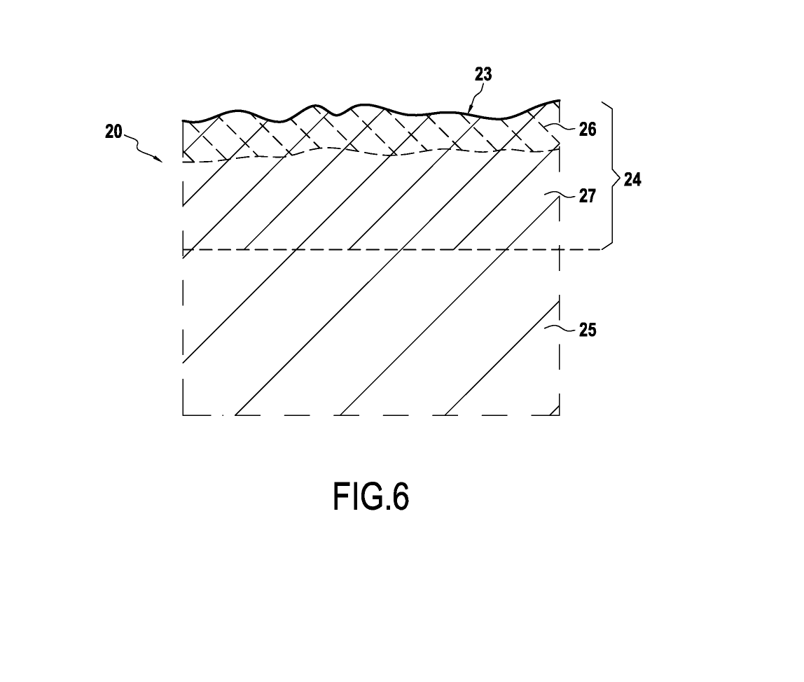

The metal core 20 is obtained by forming the core by carbonitriding an outside surface 23 of the metal core 20. Such carbonitriding can be performed in particular by forming a plasma of carbon and nitrogen, also referred to as “ion” carbonitriding or “plasma” carbonitriding. This reaction technique serves to cause carbon and nitrogen to diffuse in depth into the metal core 20 and to create at the surface 23 of the metal core 20 a layer 24 of material that is enriched in metallic carbonitride. As can be seen in FIG. 6, a metal core 20 is thus obtained that presents on its outside surface 23 a layer 24 made of material that is enriched in metallic carbonitride. Under the layer 24 of metallic carbonitride enriched material, there can be found the composition 25 of the nickel- or cobalt-based alloy used for forming the metal core 20 prior to the carbonitriding treatment.

As shown in FIG. 6, the layer 24 of material enriched in metallic carbonitride may comprise a first layer 26 and a second layer 27, the first layer 26 having a greater concentration of metallic nitride than the second layer 27, and the second layer 27 being separated from the outside surface 23 of the metal core 20 by the first layer 26.

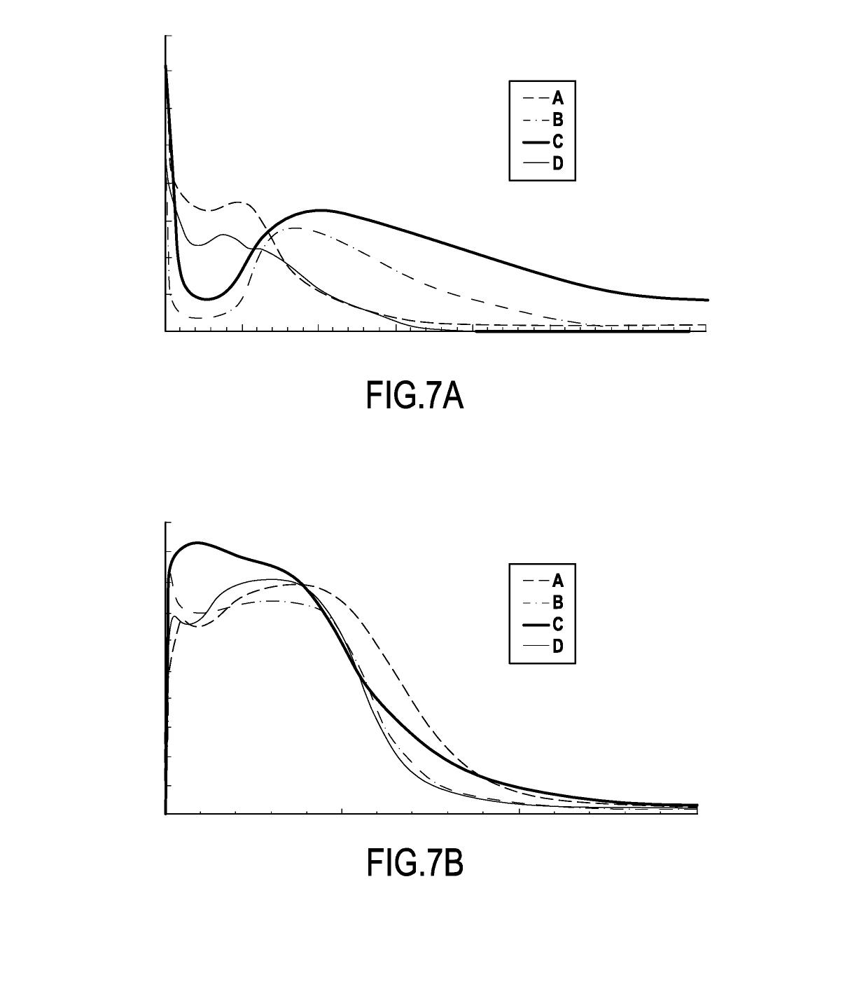

FIGS. 7A and 7B show the concentrations respectively of carbon and of nitrogen going from the outside surface 23 of the metal core 20 towards the inside of the metal core 20 substantially perpendicularly to its outside surface 23, with this being done for various different nickel- or cobalt-based alloys (referenced A-D). It can be seen that nitrogen is present above all in the first layer 26 and that its concentration falls off quite quickly on going towards the inside of the metal core 20. With the exception of alloy A, the concentration of carbon is generally lower in the first layer 26 and tends to increase in the second layer 27 prior to decreasing once more on reaching the nickel- or cobalt-based alloy 25 used for making the metal core 20, prior to the carbonitriding treatment.

It can be understood that the concentrations of carbon and of nitrogen in the first and second layers 26 and 27 vary in continuous manner. The layer 24 of material enriched in metallic carbonitride thus comprises metallic nitrides, metallic carbides, and/or metallic carbonitride. Nevertheless, since the first layer 26 has a higher concentration of nitrogen than the second layer 27, its concentration of metallic nitride (in the form of nitride and/or of material based on carbonitride) is higher than that of the second layer 27.

By way of example, the ion carbonitriding may be performed at 500° C. for 150 hours (h). These conditions make it possible to obtain a layer of material enriched in carbonitride having thickness lying in the range 20 μm to 30 μm. It is also possible to envisage performing ion carbonitriding at 720° C. for 150 h.

After being subjected to a plurality of hot-shaping thermal cycles, the layer 24 of material enriched in carbonitride might become damaged. The layer 24 of material enriched in metallic carbonitride on the metal core 20 can then be enriched by performing a new step of carbonitriding the metal core 20. This produces a new layer 24 of material in metallic carbonitride.

The new step of carbonitriding the metal core 20 can be performed directly on the metal core 20 having its layer 24 of material enriched in metallic carbonitride that has become damaged, or it is also possible to perform heat treatment at a temperature higher than the hot-shaping temperature in order to remove the damaged layer 24 of material enriched in metallic carbonitride and then perform a new step of carbonitriding the outside surface 23 of the metal core 20.

It is thus possible to reuse the metal core 20 and to subject it to a plurality of hot-shaping cycles. The number of hot-shaping cycles to which the metal core 20 is subjected can thus be increased.

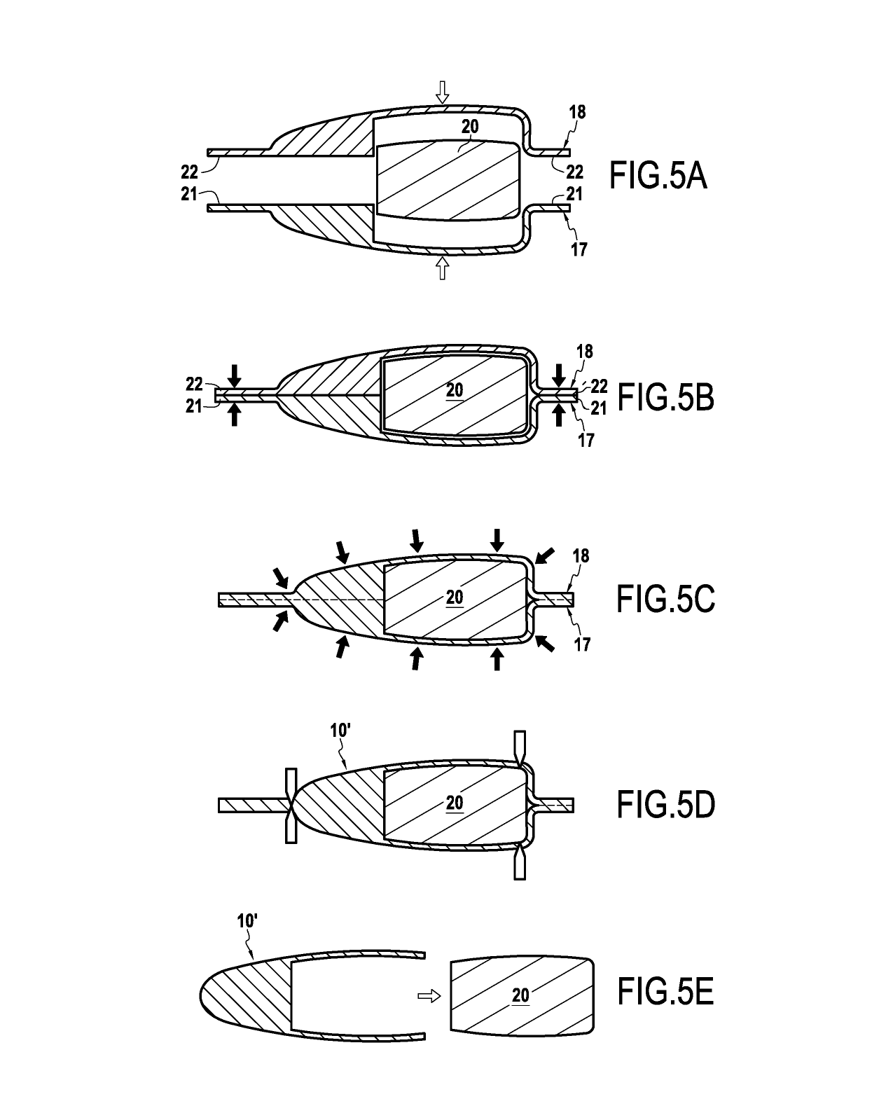

The method of hot-shaping a metal part 10 made of titanium-based alloy around the metal core 20 is shown in FIGS. 5A to 5E. It comprises steps of positioning the metal part around the core 20 (FIGS. 5A and 5B), of hot-shaping the metal part 10′ around the metal core (FIG. 5C), and of extracting the metal core from the metal part 10′ (FIGS. 5D and 5E). In this example, it should be observed that after hot-shaping, the metal part is cut (FIG. 5D) so as to make it possible to extract the core 20 (FIG. 5E). A leading edge shield 10′ is thus obtained that can be positioned on and attached to the leading edge of the blade.

It should be observed that the method of hot-shaping the metal part 10 does not include a step of machining the surface of the leading edge 5 that is to be put into contact with the blade.

Specifically, during the hot-shaping step there is no sticking and/or chemical reaction between the metal core 20 and the metal part 10, since the metal part 10 is in contact with the layer 24 of material enriched in metallic carbonitride, and not with the nickel- or cobalt-based alloy 25 forming the metal core.

Furthermore, the layer 24 of material enriched in metallic carbonitride is chemically and physically inert relative to the metal part 10. As a result of its dispersion of carbides and nitrides, this layer 24 forms a diffusion barrier between the alloy of the metal core 20 and the titanium-based alloy of the metal part 10. This serves to limit contamination of the metal part 10 made of titanium-based alloy by elements from the nickel- or cobalt-based alloy of the metal core 20.

This shaping method may include steps of fabricating the metal core 20 or steps of regenerating the metal core 20, as described above.

Although the present invention is described with reference to a specific embodiment, it is clear that various modifications and changes may be made to those embodiments without going beyond the general ambit of the invention as defined by the claims. For example, the invention is not limited to leading edge shields for rotary blades. Specifically, the metal core and the fabrication and regeneration methods can be used for fabricating any other metal part made of titanium-based alloy by hot-shaping around a metal core as defined. In addition, individual characteristics of the various embodiments mentioned may be combined in additional embodiments. Consequently, the description and the drawings should be considered in a sense that is illustrative rather than restrictive.

1. A metal core for hot-shaping a metal part made out of titanium-based alloy, wherein the metal core comprises an alloy based on nickel or on cobalt, in that the nickel- or cobalt-based alloy includes chromium, molybdenum, and/or titanium, and wherein the metal core also presents on an outside surface that is to come into contact with the metal part, a layer comprising a material that is enriched in metallic carbonitride relative to said alloy.

2. The metal core according to claim 1, wherein the layer of material enriched in metallic carbonitride comprises a first layer and a second layer, the first layer having a greater concentration of metallic nitride than the second layer, and the second layer being separated from the outside surface of the metal core by the first layer.

3. The metal core according to claim 1, wherein the layer of material enriched in metallic carbonitride presents a thickness of at least 20 μm, preferably of at least 30 μm.

4. A fabrication method for fabricating a metal core according to claim 1, comprising:
fabricating the metal core; and
carbonitriding the outside surface of the metal core in such a manner as to obtain a layer of material enriched in metallic carbonitride.

5. The fabrication method according to claim 4, wherein the outside surface of the metal core is carbonitrided by forming a plasma of carbon and of nitrogen.

6. A regeneration method for regenerating a metal core according to claim 1, said method comprising a step of carbonitriding the outside surface of the metal core so as to obtain a new layer of material enriched in metallic carbonitride.

7. The regeneration method according to claim 6, wherein, prior to the new step of carbonitriding the outside surface of the metal core, a step is performed of using heat treatment to eliminate the layer of material enriched in metallic carbonitride.

8. A shaping method for hot-shaping a metal part made out of titanium-based alloy, the method comprising:
positioning the metal part around a metal core according to claim 1;
hot-shaping the metal part around the metal core; and
extracting the metal core.

9. The shaping method according to claim 8, wherein the metal part is a leading edge shield of a rotary blade.
